(19) United States
(12) Patent Application Publication
(10) Pub. No.: US 2016/0157670 A1
(43) Pub. Date: Jun. 9, 2016

(54) APPARATUS AND METHOD FOR AUTOMATED HANDLING OF FEEDING FORMULA BOTTLES FOR BABIES

(71) Applicants: Dina NIRON, Tel Aviv (IL); Daphna BLUMENTHAL, Tel Aviv (IL)

(72) Inventors: Dina NIRON, Tel Aviv (IL); Daphna BLUMENTHAL, Tel Aviv (IL)

(21) Appl. No.: 14/907,283

(22) PCT Filed: Jul. 24, 2014
(86) PCT No.: PCT/IL2014/050673

§ 371 Date: Jan. 24, 2016

Related U.S. Application Data
(60) Provisional application No. 61/858,137, filed on Jul. 25, 2013.

(51) Int. Cl. A47J 31/60; A61J 9/06

(52) U.S. Cl. CPC A47J 31/60; A61J 9/0646

(57) ABSTRACT

Apparatus and methods are disclosed for handling baby bottle and preparing formula bottle for a baby. The apparatus and method disclose automated process that washes, sterilizes and dries a baby bottle, a baby bottle nipple and cap and any other related parts and automatically feeds formula powder, from a powder container or from a powder capsule, to the bottle along with the right amount of water in a defined water temperature. The apparatus is adapted to keep a prepared formula bottle for long periods by chilling the bottle and is adapted to heat the formula bottle prior to its intended use to a defined use temperature.

### BACKGROUND

Appliances for preparing formula bottle for a baby are known in the art however none of these appliances provides the whole cycle of handling formula feeding for a baby, from washing, through sterilizing, drying, formula preparation, heating and cooling as may be desired.

### SUMMARY OF EMBODIMENTS OF THE INVENTION

Embodiments of the present invention provide an apparatus and methods for automated and semi-automated washing and sterilizing of bottles and for automated and semi-automated preparation of feeding formula for babies.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic block diagram of an apparatus for washing and sterilizing bottles and for preparing feeding formula for babies, according to an embodiment of the present invention;

FIGS. 2A and 2B schematically depict formula feeder assembly 200, built and operative according to embodiments of the present invention, in side elevation and top elevation views, respectively;

FIG. 3 is a schematic illustration of apparatus for feeding formula bottle preparation according to embodiments of the present invention, showing a partial assembly shown in the washing and sterilizing position;

FIG. 4 is a schematic illustration of apparatus for feeding formula bottle preparation according to embodiments of the present invention showing a partial assembly shown in the formula feeding and preparation position; and

FIG. 5 is a flowchart of a method for automated washing and sterilizing of bottles and for automated feeding formula preparation, according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

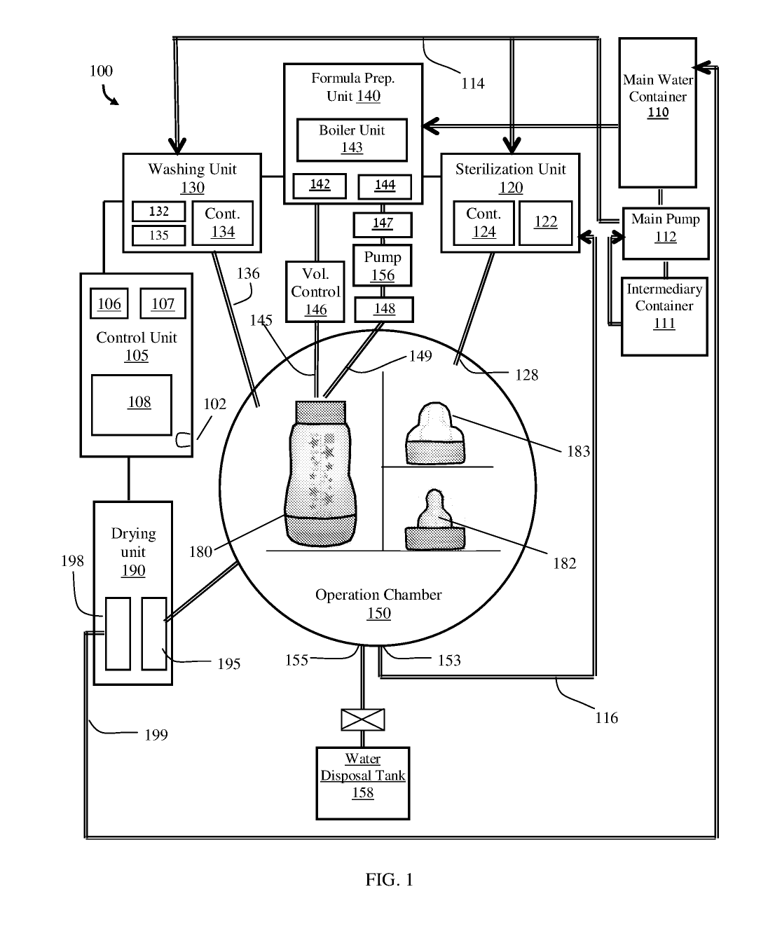

Reference is now made to FIG. 1 which is a schematic block diagram of apparatus 100 for feeding formula bottle preparation. Apparatus 100 is adapted for washing and sterilizing feeding bottles and for preparing feeding formula for babies, according to an embodiment of the present invention. Formula bottle preparation apparatus 100 may comprise a main operation chamber 150 adapted to receive at least one bottle 180, at least one nipple 182 and at least one bottle cap 183 and to contain all preparation stages of a feeding formula bottle, as is explained in details herein below. According to some embodiments, chamber 150 may be a rotatable drum.

Formula bottle preparation apparatus 100 may further comprise control unit 105, main water container 110, bottle washing unit 130, bottle sterilization unit 120, and formula preparation unit 140.

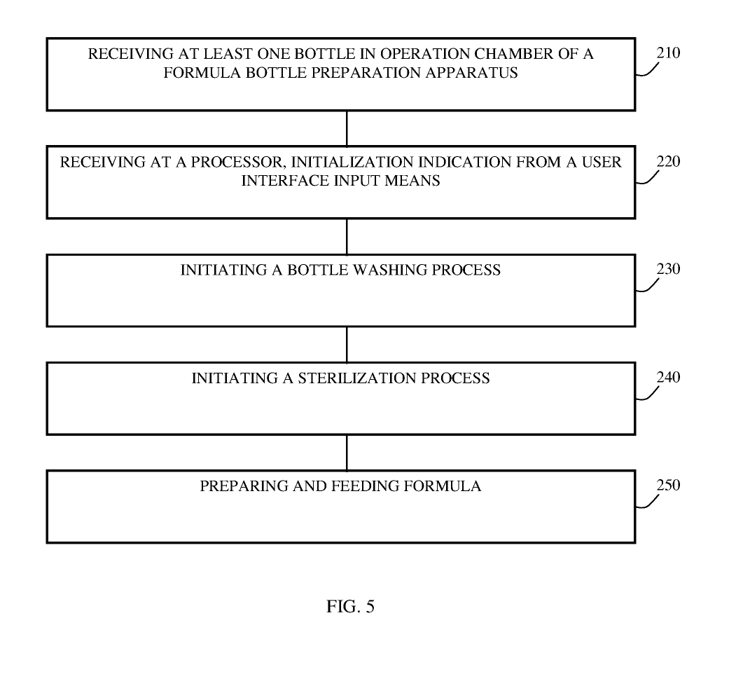

Control unit 105, according to some embodiments of the present invention, may comprise processor 106, memory 107 and user interface 108. User interface 108 may comprise input means (not shown) to receive operation instructions from a user and output means (not shown) such as a display for providing information and indications to the user during operation of formula bottle preparation apparatus 100. Processor 106 may be in active communication with one or more sensors, such as water level indicators in water containers, thermometers, formula level indicator and the like, and/or actuators (not shown) of main water container 110, bottle washing unit 130, bottle sterilization unit 120, formula preparation unit 140 and chamber 150, as well as with user interface 108. It would be appreciated that upon receipt of an input from a user, processor 106 may coordinate the operation of different units of apparatus 100 to produce a clean, sterilized and accurately prepared feeding formula bottle 180, as will be further described with reference to FIG. 5.

Apparatus 100 may further comprise a power source, such as a rechargeable battery (not shown) and/or may receive power from an external power source, via a power inlet 102.

According to some embodiments of the present invention, bottle washing unit 130 may comprise a washing water container 134 and a heating unit 132. It would be appreciated that main pump 112 may pump water from main water container 110 to an intermediary container 111, in which water may be heated to a preset temperature, and then pumped again by pump 112 from container 111 to washing water container 134 via water supply tube 114.

Washing unit 130 may further have a washing water tube 136 to provide heated or non-heated washing water from washing water container 134 to chamber 150. The volume of washing water flowing into chamber 150 may be controlled by a volume controller (not shown) as known in the art. It would be appreciated that chamber 150 may have an inlet (not shown) adapted to receive fluids from channel 136. According to some embodiments, detergent, contained in detergent container 135, may be added to washing water prior to some or all washing cycles. It would be appreciated that at least the last washing cycle in each operation of apparatus 100 should be done with washing water only, without added detergent. According to some embodiments pressurized hot/boiling water and/or steam may be directed to flow through pipelines of apparatus 100 that are used to provide materials that may leave residual contaminants in the pipes, in order to clean the pipes at a suitable stage of the operation of apparatus 100. This stage of pipe cleaning may take place as part of an automatic cycle or may be operated manually. This pipe cleaning/washing stage may include also cleaning detergents.

According to some embodiments of the present invention, after washing the bottle(s) parts 180, 182 and 183 in chamber 150, used washing water may be drained from chamber 150 through drain outlet 155. According to some embodiments, drained water may be collected in water disposal tank 158.

Sterilization unit 120 may comprise, according to some embodiments, sterilization water container 124 and heating element 122.According to some embodiments, heating element 122 may be adapted to steam water from container 124 and stream the steam into chamber 150 for a preset time period such as for 3-5 minutes.

According to some embodiments, sterilization water container 124 may receive water supply from main water container 110 via water supply tube 114. The water from container 110 to sterilization water container 124 may be pumped by main pump 112 to an intermediary container 111, heated to a predefined temperature (e.g. 65° c) by a heating element (not shown) and pumped from container 111 to supply tube 114 by main pump 112. According to some embodiments apparatus 100 may be connected to the water supply system directly or via suitable water line filter (not shown) thus eliminating the need for main water container 110.

Sterilization unit 120 may further comprise means for streaming steam from sterilization unit 120 into chamber 150 in a predefined and controlled volume. It would be appreciated that chamber 150 may have an inlet to receive a sterilization steam tube 128, channeling steam from sterilization unit 120 into chamber 150.

According to some embodiments of the present invention, chamber 150 may have a sterilization water reuse channel 116 to collect used sterilization condensed water from chamber 150 and redirect the used water back to sterilization water container 124 for reuse. It would be appreciated that another pump (not shown) may be required in order to pump the fluid from chamber 150 and return it to container 124.

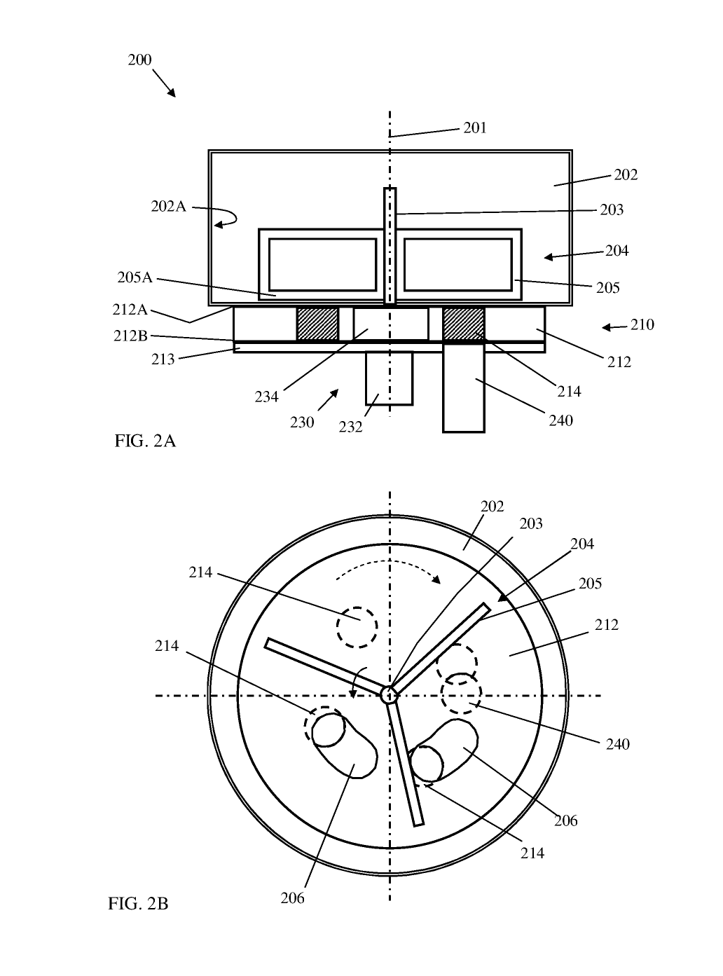

Apparatus 100 further comprises a feeding formula preparation unit 140. Formula preparation unit 140 may comprise a boiler unit 143 to be used to sanitize formula preparation water and for cooling formula preparation water to ambient temperature, A formula preparation water container 144 and a heating element 142 to heat the water in container 144 to a desired temperature suitable for feeding of a baby (e.g. 36°-39° Celsius) as may be set by the user via user interface unit 108. Preparation unit 140 may further comprise feeding formula container 147, formula dosage control means 148, such as feeding assembly 200 (in FIGS. 2A and 2B), water volume control means 146, such as a buoy and valve assembly (not shown) a water filling nozzle 145 and a formula dispenser 149. It would be appreciated that after the formula is dispensed into bottle 180, water from water container 144 may be fed into bottle 180 in a predefined pressure to ensure that the formula dissolves properly. According to other embodiments, formula may be dispensed after bottle 180 is filled with water and the mixing of the formula and water may be manually conducted. It would be further appreciated that filling nozzle 145 should be directed to a center of an opening in the top of bottle 180. According to some embodiments of the present invention formula dosage control means 148 may be adapted to prepare different formulas having different amount of prepared formula and/or different relations between its ingredients according to one or more parameters, such as time in the day/night the formula is programmed to be prepared at, age of the user, etc. According to yet additional embodiments control unit 105 may mark a bottle that was left in operation chamber 150 of device 100 with a prepared formula in it longer than definable period of time as unusable and issue a notification to the user of device 100. That definable period of time may be set by the user and may also automatically be tuned according to one or more of several variables such as target temperature the formula was prepared at, ambient temperature after the formula was prepared, etc. According to yet additional embodiments apparatus 100 may be configured to mark formula that was fed into formula preparation unit 140 as unusable according to its specific expiration date and date of pouring into formula preparation unit 140 and further according to actual ambient conditions such as temperature and humidity.

According to some embodiments, formula preparation unit 140 may comprise sealing elements on all openings, to prevent the spoilage of the formula. The sealing elements may prevent the penetration of dirt, dust, humidity and the like, into formula container 147 and to formula dispenser 149. According to some embodiments dosage control means such as dosage control means 148 may comprise, alternatively or additionally, arrangement for feeding formula powder from pre-packed packets, such as powder capsules. For example, pre-packed formula capsules according to embodiments of the present invention may be held in corresponding holding cut-outs made in the bottom of a formula feeder similar to formula feeder 200 (FIG. 2B) where such cut-outs may be covered and sealed when feeder 200 operates as described in details below with respect to FIG. 2 or may be opened and be occupied by formula powder capsule, one in each such cut-out. In this mode of operation holes 206 and 214 may be covered and sealed and agitator 205 may be modified, for example by placing a temporary add-on element (not shown) on agitator 205 that, when it passes over a formula capsule, it punctures the capsule and causes the powder that in it to be poured into a bottle placed underneath. In some additional or alternative embodiments formula capsules may be stacked in a suitable capsule holder or holders that may be installed next to feeder 200 with a suitable chute that leads to a location above an opening of a bottle. Removal of a used formula capsule may be done manually at the end of a formula preparation cycle, for example as outcome of opening of the operation chamber or following the opening of the operation chamber, or it may be done automatically as part of the automatic formula feeding process. According to some embodiments formula capsules may be marked with a machine-readable code (e.g. barcode or QR code) that may be read and recognized by the controller of apparatus 100. The machine-readable code may comprise essential information such as the type of the formula, the amount of the formula, expiration date of the formula and the like. Based on this information the controller of apparatus 100 may fine-tine the formula preparation cycle or reject the capsule and/or issue a warning notification to a user, and the like.

According to some embodiments of the present invention, boiler unit 143 may be fed with water directly from main water container 110 solely by gravity, without the need for a pump to push the water from container 110 to boiler 143.

According to one embodiment of the present invention, apparatus 100 may further comprise a drying unit 190 designed to dry bottle 180 and nipple 182 and bottle cap 183 after washing and sterilization. Drying unit 190 may comprise a venting unit 195, a condenser 198 and condensed water channel 199, to return condensed water back to one or more of water containers 110, 124, 134 and 144 for further use. According to some embodiments, drying unit 190 may draw air from chamber 150, condense vaporized water from the drawn air and blow the dried air back into chamber 150 by venting unit 195.

According to some embodiments of the present invention, control unit 105 may comprise a time-based controlling scheme to allow scheduled preparation of bottles. According to other or additional embodiments of the present invention, formula bottles may be prepared upon receipt of preparation instructions from a user. According to additional embodiments control unit 105 may allow independent operation of any one of the various sections of apparatus 100, such as independent washing, independent drying, independent sterilization and the like. Control unit 105 may further allow a user to program partial sub-cycles, such as wash the bottle two times and then sterilize it”. According to some embodiments formula preparation apparatus such as apparatus 100 may further comprise cooling unit that may provide cooling capability for cooling a prepared formula bottle from its preparation temperature to another, lower, set-point temperature that is proper for drinking of a baby or, according to additional embodiments a prepared formula bottle may be chilled to a temperature that enable long stay without degradation of he prepared formula for longer times such as tens of minutes or even for hours. In such embodiments the chilled bottle may be kept in this low temperature, that may be dictated for example by the manufacturer of the formula powder, until before the bottle with the prepared and chilled formula is about to be used, at which time the chilled bottle may be heated, for example using hot water available as described above or by means of an electrical heating element as known in the art. The re-heating may be controlled as to the set-point heating temperature and the profile of heat raising in time according to recommendations provided by the formula manufacturer, controlled by the apparatus controller.

Apparatus 100 may further comprise a bottle storage unit (not shown) for storing empty bottles prior to insertion into operation chamber 150. According to additional embodiments, apparatus 100 may comprise a prepared bottles chamber (not shown) for storing prepared feeding bottles in proper conditions until usage.

Preparation of fresh formula drink for a baby should be done as close as possible to the intended use of the formula, should keep the formula powder fresh and dry before use and should be adapted for feeding of accurate amounts of formula ingredients, to ensure properly prepared drink for the baby. Reference is made now to FIGS. 2A and 2B, which schematically depict formula feeder assembly 200, built and operative according to embodiments of the present invention, in side elevation and top elevation views, respectively.

Feeder assembly 200 comprises formula container 202, formula dosing assembly 210, driving assembly 230 and formula feeding chute 240. Formula container 202 may have an operative volume suitable for the expected period of use between two consecutive refills. For example, when formula preparation apparatus according to embodiments of the present invention, such as apparatus 100 of FIG. 1, is designed to automatically prepare three bottles of formula drink between two consecutive refills and assuming, for example, that each formula bottle contains 150 cc of formula powder, than the operative volume of container 202 will be at least 450-500 cc. Container 202 is designed to be filled/refilled manually and may be equipped with a cover (not shown) that when it is properly closed it ensures tight hermetic closure of the powder space. One or more powder providing cut-outs 206 are made in the bottom of container 202, as seen in FIG. 2B, through which formula powder may be fed solely by gravity or by the aid of pressurized air. According to some embodiments feeding of formula to a bottle may comprise two or more consecutive formula feeding cycles to a single bottle, as per a pre-programmed formula scheme or manually controlled by a user via controller 105.

Shovel agitator 204 is installed on axis 203 which passes through a hole in the bottom of container 202. Shovel agitator 204 may have one or more shovel wings 205 extending from axis 203 substantially radially towards internal wall 202A of container 202. The lower end 205A of shovel agitator wings 205 is set to be very close to the internal bottom of container 202, so that when wings 205 rotate about axis 203 their lower end 205A effectively shovels formula powder existing in container 202 over the bottom.

Formula dosing assembly 210 comprises dosing disc 212 formed as a thick disc located underneath container 202 so that the upper face 212A of dosing disc 212 closely attaches the outer face of the bottom of container 202. Dosing assembly 210 is adapted to independently turn about its own axis (not shown to avoid in-clarity) that coincides with axis 203 along turning line 201. One or more dosing cavities 214 are made in dosing disc 212 from its upper outer face 212A to its lower outer face 212B. The volume of dosing cavities 214 is set to define one exact portion of N portions of the smallest dose of formula powder that is defined for the formula feeding apparatus according to embodiments of the present invention. For example, in case where the smallest formula dose planned for the apparatus is 60 cc (which is equivalent to 9 grams of formula powder), the volume of cavity 214 may be set to 30 cc (equivalent to 4.5 grams of formula powder) in which case 2 volumes of cavity 214 will be needed in order to complete the required formula dose. Dosing cavities 214 are located centered on an imaginary circle centered on turning line 201 and preferably evenly spaced on that circle. The radius of the imaginary circle equals to the distance of feeding cut-outs 206 from turning line 201, and the shape of feeding cut outs 206 may resemble a bean which overlaps the trace of dosing cavity 214 in the top elevation, as it moves along a certain sector, herein after the feeding sector. When dosing cavity is exposed, at least partially, to feeding cut-out 206, formula powder in container 202 is free to fall into dosing cavity 214. The number of feeding cut-outs 206 and their circular spacing and the number of dosing cavities 214 and their circular spacing is designed so that there is at least one angular position of dosing disc 212 in which no dosing cavity is exposed to any one of cut-outs 206 and as a result all cut-outs 206 are fully covered, and the formula is maintained fresh and dry, at this at least one angular position, herein after no-feed angular position(s).

At rest position dosing disc 212 may be stopped at one of the no-feed angular positions. When preparation of a new formula bottle is required dosing disc 212 may controllably be turned about its axis so that dosing cavities 214 are exposed to feeding cut-outs N times, to provide the required amount of formula powder, where N is the number dosing formula cavity volumes required to complete the amount of formula powder.

In order to ensure that each dosing cavity 214 is filled completely during the time it passes under feeding cut-out 206 shovel agitator 204 may concurrently be turned to shovel enough formula powder towards cut-outs 206.

Bottom disc 213 is statically located underneath dosing disc 212 so that the upper face of bottom disc 213 closely attaches lower outer face 212B of dosing disc 212. Feeding chute 240 is located in a respective hole made in bottom disc 213; the hole is located on an imaginary circle having the same radius as that on the circumference of which dosing cavities 214 are located and its internal radius equals to the internal radius of dosing cavities 214, or somewhat bigger than this radius. During the rotation of dosing disc 212 each dosing cavity 214, when passing over feeding chute 240 and at least partially overlapping it, unloads its content of formula powder into feeding chute 240. When dosing cavities 214 have passed over feeding chute N times full amount of formula powder has been unloaded into feeding chute 240. In angular positions of dosing disc where no dosing cavity 214 overlaps, even partially, feeding chute 240, and dosing cavity 214 overlaps any feeding cut-out 206 even partially container 202 is isolated from the ambient environment and feeding chute 240 is completely isolated from both dosing disc 212 and from container 202.

Shovel agitator 204 and dosing disc 212 may be rotationally driven by a single motor, such as motor 232. Motor 232 may be connected to drive gear 234. Gear 234 may be any suitable gear that may provide separated rotational movements to shovel agitator 204 and to dosing disc 212. According to embodiments of the present invention gear 234 may be a planetary gear, which may provide two different rotational drives at its output in response to a single rotational drive, such as motor 232. In an embodiment where gear 234 is a planetary gear the ratio of rotational speeds of dosing disc 212 to that of shovel agitator 204 may be set by proper selection of the gear's sets of wheels. According to embodiments of the present invention the rotational speed of shovel agitator 204 to that of dosing disc 212 may be higher than 1:1, for example 1:3, which ensures sufficient provision of the formula powder to dosing cavities 214. In case where gear 234 is a planetary gear typically the directions of rotation of shovel agitator 204 and that of dosing disc 212 will be opposite to each other.

Motor 232 may be any electrical motor the amount of its rotations, or part of a rotation is controllable, for example a stepper motor. The control of motor 232 may be done by control unit 105 (FIG. 1). Formula feeder assembly 200 may be also equipped with an absolute angular position indicator, to allow for homing functionality after each startup of the apparatus.

According to embodiments of the present invention formula feeder assembly 200 may comprise container 200 of approximately 3500 cc of formula powder, which equals to approximately 500 gr, dosing disc 212 with 4 dosing cavities each one of exactly 4.5 gr of formula powder (approx. 30 cc) and shovel agitator 204 with 3 shovel wings 205. It would be appreciated though that other measurements may be used without deviating from the spirit of the invention.

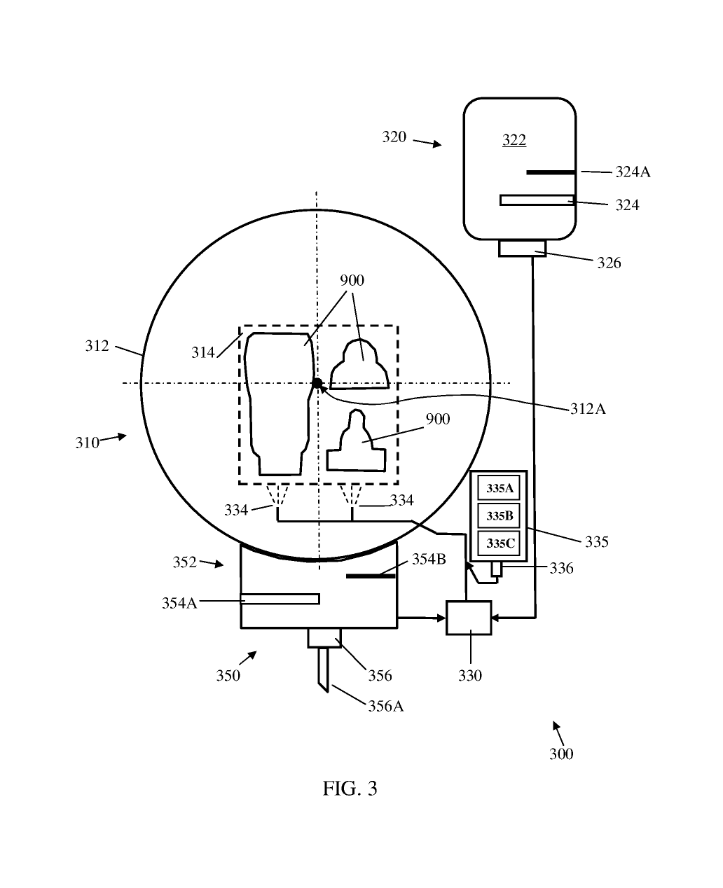

Reference is made now to FIG. 3, which is a schematic illustration of apparatus for feeding formula bottle preparation according to embodiments of the present invention showing partial assembly 300 shown in the washing and sterilizing position. Partial assembly 300 comprise wash-sterilize-formula feed drum 312 turnable about axis 312A, washing water holding and treating assembly 320, water pump 330, water collecting and boiling basin 350 and detergent supply assembly 335. Water assembly 320 comprises water tank 322, water heating element 324, first water valve 326 and first water temperature sensor 324A. water pump 330 may be adapted to select one of two inputs ports for pumping its content towards a third port while keeping the other input port closed or maintain both input ports closed. Detergent assembly 335 comprises detergent container 335A, detergent valve 335B and detergent one-way/mixer valve 335C. Water collecting and boiling basin 350 comprises water tank 352, water heating/boiling means 354A and water temperature sensor 354B. Water pump 330 may be fed in its input ports from water tank assembly 320 and from water basin 350 and may provide pumped water to water/steam nozzles 334. When in the washing and sterilizing position drum 312 is positioned so that washable articles 900, such as formula bottle, bottle nipple and bottle cap, are placed their openings facing down secured within was and sterilize cage 314. Nozzles 334 are located and directed so as to provide pressurized water from below upwardly directed into the openings of articles 900.

Washing and sterilizing cycles may start with heating of the water in water reservoir 320 to washing-suitable temperature, for example to 65° c. When the water are heated to the required temperature, as sensed by first temperature sensor 324A, valve 326 opens and into pump 330 starts pumping water from tank 322 and detergent from detergent assembly 335 mixes with the pumped water at one-way/mixer valve 335C. The pumped mix of heated water and detergent is forcefully sprayed into articles 900 to wash their interior spaces. The amount of water consumed from water tank 322 may be metered to equal a predefined amount. Water sprayed onto articles 900 drop gravitationally into basin 350 and may be collected in it. Once the predefined amount was consumed and first washing cycle terminated several more washing cycles may be carried out using the mix of water and detergent collected in basin 350. For these additional washing cycles the collected mix may be sprayed similarly to the firs cycle only these times pump 330 is fed with fluid via its second port. In these additional washing cycles the temperature of the water in basin 350 may be heated by heating means 354A and be controlled relying on temperature indication received from temperature sensor 354B. Detergent washing cycles may be repeated as many times as required, considering also the time available for detergent washing and the expected efficiency of further repeated cycles. At the end of the detergent washing process the washing water may be dumped via waste water dump valve 356. According to some embodiments, washing water may be drained directly to the sewer system (not shown).

In order to begin clean water washing cycles water from tank 322 may be pumped towards nozzles 334 only this time no detergent is added. The sprayed water again may be collected in basin 352 for repeated washing cycles, for example 3 cycles. At the end of these 3 cycles the washing water may be dumped via waste water dump valve 356.

Now another clean water washing process may begin, for higher grade of cleaning, and may similarly be repeated 2 or more times. The water of this third washing process are accumulated in basin 352.

For sterilization the water accumulated in basin 352 may be boiled to 100° c so that steam sterilizes articles 900.

According to embodiments of the present invention tank 322 may contain about 1 liter which may suffice for washing and sterilizing of two groups of articles. The amount of water required for one full wash and sterilize cycle is about 450 cc. According to embodiments of the present invention the water kept in tank 322 may be kept in 65° c or may be heated to this temperature when required. The duration of full process of wash and sterilize is about 8 minutes. Optionally tank 322 may comprise low-level indicator to issue a water low-level warning and/or disable the automatic operation of the apparatus. Pump 330 may be, according to embodiments of the present invention, of the diaphragm type, having capacity of 2.6 LPM and pressure of up to 5.5 Bar.

The operation of the washing and sterilizing may be controlled, for example, by control unit 105 (FIG. 1).

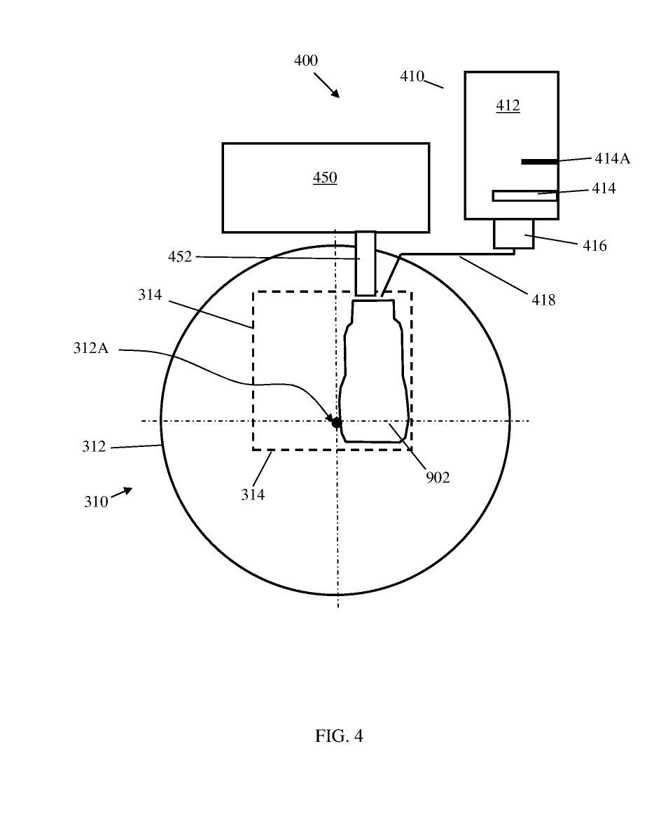

Reference is made now to FIG. 4, which is a schematic illustration of apparatus for feeding formula bottle preparation according to embodiments of the present invention showing partial assembly 400 shown in the formula feeding and preparation position. Partial assembly 400 comprise wash-sterilize-formula feed drum 312 turnable about axis 312A, formula water assembly 410 and formula powder feeding assembly 450. Water assembly 410 comprises water tank 412, water heating means 414 and water temperature sensor 414A. As explained above washed articles may be kept in place in cage 314, so that when drum 312 is turned to its formula feed position, bottle 902 is located so that its opening is placed close to and underneath the lower tip of formula water feeding pipe 418 and underneath formula feeding chute 452 of formula metering and feeding assembly 450. Before formula feeding process begins the water in tank 412 may be sanitized. The sanitization process includes boiling the water in tank 412 to 100° c for about 5 minutes and allowing the water to cool down to ambient temperature either spontaneously or by forced chilling (not shown). Estimated spontaneous cool down time is typically 20-40 minutes, depending on the volume of tank 412 and the ambient temperature. An accurate volume of s Sanitized water may now be fed, by a sanitized water pump 416, for preparation of formula in 36° c-39° c. According to some embodiments, sanitized water pump 416 may be a peristaltic pump, or any other pump known in the art, that is capable of providing an accurate volume of water. According to some embodiments the heating up of the sanitized water may take place concurrently with the washing process. When apparatus 100 operates automatically and tank 412 has sufficient amount of water the sanitizing process may be started shortly after a previous formula has been fed into bottle(s) 902. This may ensure that there will be no need to delay preparation for the next feeding cycle, which is typically expected to take place 2.5 to 3 hours after previous feeding. The operation of the water sanitizing and formula feeding 400 may be controlled, for example, by control unit 105 (FIG. 1).

Metering pump 412 may have, according to embodiments of the present invention, capacity of 1 LPM and may be of any type, such as positive displacement type. Filling the water to bottle 902 may last about 20 seconds and during that time formula metering and feeding assembly 450, operating as described with regards to assembly 200 of FIGS. 2A and 2B, may feed metered amount of formula powder into bottle 902.

According to additional embodiments of the present invention apparatus 100 may comprise more than one operation chamber, such as operation chamber 150. This may allow preparation of more than a single bottle at a given period of time, for example if the apparatus for preparation of feeding formula needs to serve twin babies. For example several operation chambers may be disposed side-by-side and be adapted to operate independently of each-other both in timing and formula thus allowing preparation of several and different formulas concurrently. According to some embodiments apparatus 100 may comprise a multi-bottle operation chamber that includes all the options and functionality described with regards to operation chamber 150 and additionally location, in it for several additional bottles that may be handled similarly to the handling of a single bottle as described above as to feeding of formula into the bottle. Yet, the other bottles in the multi-bottle operation chamber may be subject to all other elements of the bottle cycle, such as washing, drying, sterilizing and the like concurrently or independently of each other. Feeding of formula to any of the other bottles in the multi-bottle operation chamber may be done by moving the formula feeder from an opening of one opening of one bottle to another as may be required—all of these operations may be controlled by a controller such as control unit 105, in an automatic, semi-automatic or manual cycle. In yet additional embodiment a multi-bottle chamber may be adapted to feed formula only to a bottle located in a certain position in the multi-bottle chamber and other bottles in the multi-bottle chamber may be subject to all other elements of the bottle handling cycle.

According to some embodiment the structure and functionality of operation chamber 150 or of a multi-bottle chamber may receive and handle formula bottles, nipples and caps of large variety of sizes and forms, e.g. all sizes and forms known in the market.

Reference is now made to FIG. 5 which is a flowchart of a method for automated washing and sterilizing of bottles and for automated feeding formula preparation, according to embodiments of the present invention, the method may comprise the following steps:

Receiving at least one bottle in operation chamber of a formula bottle preparation apparatus [block 210].

Receiving at a processor, initialization indication from a user interface input device [block 220].

Initiating a bottle washing process [block 230]. The washing process may comprise: heating water to a predefined temperature such as 60° c-70° c. Infusing heated water into the operation chamber of the formula bottle preparation apparatus, and draining used washing water from the chamber.

According to some embodiments, washing process may comprise, prior to draining, spinning the operation chamber.

According to some embodiments washing process may further include introducing a detergent into operation chamber and draining the detergent together with the washing water.

According to some embodiments, after the washing process is completed, a sterilization process may be initiated [block 240]. The sterilization process may comprise the following steps:

Heating water to a boiling point and streaming steam into operation chamber; and

Collecting water condensed during the steaming process and pumping fluids from the chamber back to sterilization unit for reuse.

A method according to embodiments of the present invention may further comprise a formula preparation step [block 250]. Formula preparation step may comprise dispensing a predetermined dose of formula into a bottle, and filling the bottle with a predefined volume of preheated water. It would be appreciated that the water filled in the bottle may be filled in a predefined pressure to ensure that the formula sufficiently dissolve in the preheated water.

According to some embodiments of the present invention, a drying process may be initiated prior to the formula preparation stage. According to other embodiments, the drying stage may not be required.

According to some embodiments of the present invention, an indication may be displayed at the beginning and/or end of each of or some of the stages.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A feeding formula bottle preparation apparatus comprising:
an operation chamber adapted to receive and contain at least one bottle, at least one nipple and at least one bottle cap;
a control unit comprising:
a processor;
a memory; and
a user interface;
a main water container;
a main pump;
a bottle washing unit;
a bottle sterilization unit; and
a formula preparation unit; wherein said formula preparation unit comprises:
a boiler unit adapted to sanitize formula preparation water and for cooling formula preparation water to ambient temperature;
a formula preparation water container;
a water volume control device; and
a feeding assembly;
wherein said processor of said control unit is in active communication with at least one sensor,
at least one actuator and with said user interface, and
wherein said feeding assembly comprises:
a formula container;
a formula dosage assembly;
a driving assembly; and
a formula feeding chute.

2. The feeding formula bottle preparation apparatus according to claim 1 wherein said bottle washing unit comprises:
a washing water container;
a heating unit;
a detergent container; and
a washing water tube, to provide washing water and detergent to said operation chamber.

3. The feeding formula bottle preparation apparatus according to claim 1 wherein said sterilization unit comprises:
a sterilization water container;
a heating element to steam water from said sterilization water container and stream said steam to said operation chamber for a sterilization time period.

4. The feeding formula bottle preparation apparatus according to claim 3 wherein said sterilization time period is in the range of 3 to 5 minutes.

5. The feeding formula bottle preparation apparatus according to any one of claims 3 and 4 wherein said sterilization water container comprises an inlet to receive water from said main water container via a water supply tube.

6. The feeding formula bottle preparation apparatus according to claim 1 wherein said operation chamber is a rotatable drum.

7. The feeding formula bottle preparation apparatus according to claim 1 wherein said operation chamber comprises at least one inlet to receive washing materials from said washing unit, sterilization materials from said sterilization unit and feeding formula and feeding water from said formula preparation unit.

8. The feeding formula bottle preparation apparatus according to claim 1 wherein said formula container has at least one cutout at the bottom thereof, wherein formula powder is fed to said at least one bottle through said at least one cutout by gravity.

9. The feeding formula bottle preparation apparatus according to claim 8 wherein said formula container comprises a shovel agitator, said shovel agitator is installed on an axis passing through a hole in the bottom of said formula container.

10. The feeding formula bottle preparation apparatus according to claim 9 wherein said shovel agitator comprises at least one shovel wing extending radially from said axis, towards an internal wall of said formula container.

11. The feeding formula bottle preparation apparatus according to claim 10 wherein said at least one shovel wing is set to shovel formula powder in said formula container, over the bottom of said formula container, when said at least one shovel wing rotates about said axis.

12. The feeding formula bottle preparation apparatus according to claim 11 wherein said formula dosage assembly comprises a dosing disc formed as a thick disc located underneath said formula container so that the upper face of said dosing disc is attached to the outer face of the bottom of said formula container.

13. The feeding formula bottle preparation apparatus according to claim 12 wherein said dosage assembly is independently rotatable about a dosage assembly axis, wherein said dosage assembly axis coincides with said axis passing through said hole in the bottom of said formula container, and
wherein said dosing disc comprises at least one dosing cavity adapted to receive formula powder from said formula container when said at least one dosing cavity is at least partially exposed to said at least one cutout.

14. The feeding formula bottle preparation apparatus according to any one of the preceding claims wherein said user interface comprises an input device and an output device, and wherein said output device is a display.

15. The feeding formula bottle preparation apparatus according to any one of the preceding claims wherein said at least one sensor is selected from a group consisting of: water level indicators in said water containers, thermometers and formula level indicator.

16. The feeding formula bottle preparation apparatus according to any one of the preceding claims wherein said at least one actuator is selected from a group consisting of: main water container actuator, bottle washing unit actuator, bottle sterilization unit actuator, formula preparation unit actuator and main operation chamber actuator.

17. The feeding formula bottle preparation apparatus according to claim 1 further comprising a drying unit, wherein said drying unit comprises a venting unit, a condenser and condensed water channel to return condensed water at least to said main water container.

18. A method for automated washing and sterilizing of bottles and for automated feeding formula preparation comprising:
receiving at least one bottle in an operation chamber of a formula bottle preparation apparatus;
receiving at a processor initialization indication from a user interface input device;
initiating a bottle washing process;
initiating a sterilization process; and
preparing a feeding formula bottle.

19. The method according to claim 18 wherein said bottle washing process comprises:
heating water to a predefined temperature;
infusing heated water into the operation chamber of the formula bottle preparation apparatus; and
draining used washing water from the chamber.

20. The method according to claim 19 wherein said predefined temperature is in the range of 60° c-70° c.

21. The method according to any one of claims 19 and 20 further comprising, prior to draining, spinning said operation chamber.

22. The method according to any one of claims 19-21 further comprising introducing a detergent into operation chamber and draining the detergent together with the washing water.

23. The method according to any one of claims 18-22 wherein said sanitizing processes comprises steaming water and streaming said steamed water into operation chamber.

24. The method according to claim 23 further comprising collecting water condensed during the steaming process and pumping said condensed water from the chamber back to sterilization unit for reuse.

25. The method according to any one of claims 18-24 wherein said preparing a feeding formula bottle comprises dispensing a predetermined dose of formula into a bottle, and filling the bottle with a predefined volume of preheated water.

26. The method according to any one of claims 18-25 further comprising a drying process, wherein said drying process is initiated prior to the formula preparation stage.
